(19) United States
(12) Patent Application Publication
(10) Pub. No.: US 2004/0025290 A1
(43) Pub. Date: Feb. 12, 2004

(54) Bump stopper for a mobile part of a car body

(76) Inventor: Walter Novarino, Rivalta (IT)

Correspondence Address: MERCHANT & GOULD PC, P.O. BOX 2903, MINNEAPOLIS, MN, 55402-0903, US

(21) Appl. No.: 10/399,988

(22) PCT Filed: Oct. 30, 2001
(86) PCT No.: PCT/EP01/12514

(30) Foreign Application Priority Data
Nov. 9, 2000 (IT) TO2000A001052

(51) Int. Cl. E05F 5/02

(52) U.S. Cl. 16/86 A

(57) ABSTRACT

Description of a bump stopper for a mobile part in the car body of a motor-vehicle, consisting of a fixed element (3) that can be secured into a seat of the car body an of a mobile element (25) that can be co-axially connected to the fixed element, and which can be translated along its axis, and locked in the desired position as a consequence of said rotation. The transversal section of said fixed element (3) is basically triangular and can be snapped into a hole seat made on the fixed element (15) of the car body. The section of the mobile element (25) is basically circular, the mobile element being provided with means (28) to Fit it on an upper element (17) of said fixed element external to the body of the motor-vehicle.

The present invention refers to an adjustable bump stopper for a mobile part of a car body which is to be bump shut, in particular for the bonnet and/or the hatchback door.

This type of stopper, made of soft plastic material is already known to the experts in the field. A thread part of square section, is to be screwed into a round hole made on the car body in a proper position. The adjustment of the position of the stop surface of the stopper, in order to align the surface of the bonnet to the rest of the car body, is achieved by screwing or unscrewing the stopper into the thread seat a relatively long time being necessary to do it. Besides, since the compliance of the stopper is taken into account, due to the fact that when the bonnet is closed the stopper is compressed in order to reduce the vibrations during the running, the stopper itself must protrude from the car body by a predefined measure that cannot always be achieved.

Different adjustable stopper are also known which are positioned and adjusted by means of a minimum amount of operations. This kind of adjustment allows to position the stopper always in the same predefined position in the design phase.

German Patent n. DE 4011186 shows a stopper of this type, basically consisting of a fixed element that can be inserted into a seat of the car body and of a mobile element that can be positioned on the fixed part at an adjustable height. The mobile element is fixed by means of a screw into the adjusted position achieved at the closing of the bonnet or hatchback door with which it interacts and at that moment it moves by a predetermined length upwards due to a relative rotation between the fixed part and the mobile part caused by the screw that bumps on the mobile part where it is screwed. This stopper complies with its function, that is makes it easier to adjust the stopper quite precisely, yet it forces the operator to use a screw which has to be screwed, by means of a special tool, inside one of the component elements of the stopper. This means that the operator can make a mistake and that the assembly time is still rather long.

It is an object of the present invention to provide a stopper that can be more quickly adjusted and that does not requires the operator to use any special tool.

Said object is achieved by means of a bump stopper for a mobile part of a car body presenting the characteristics set forth in claim 1.

Additional characteristics and advantages will become more clear from the following description which is provided as non-restrictive example and which refers to the appended drawings in which:

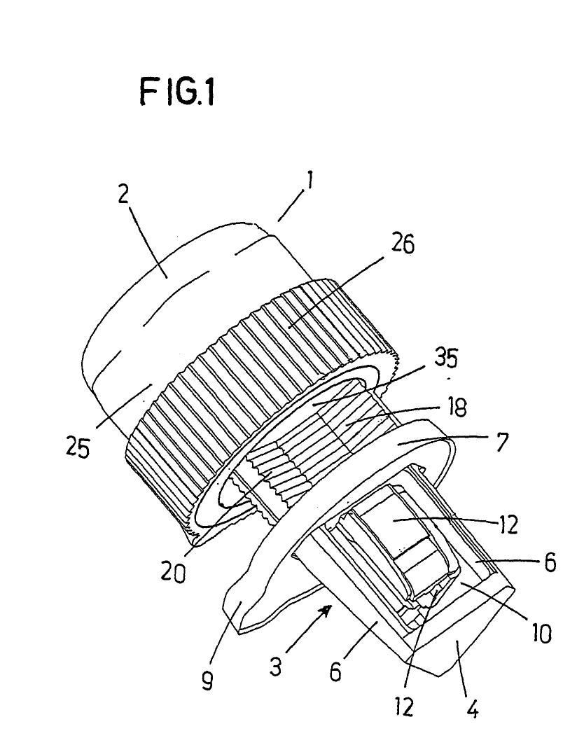

FIG. 1 is a perspective view of the stopper according to the present invention,

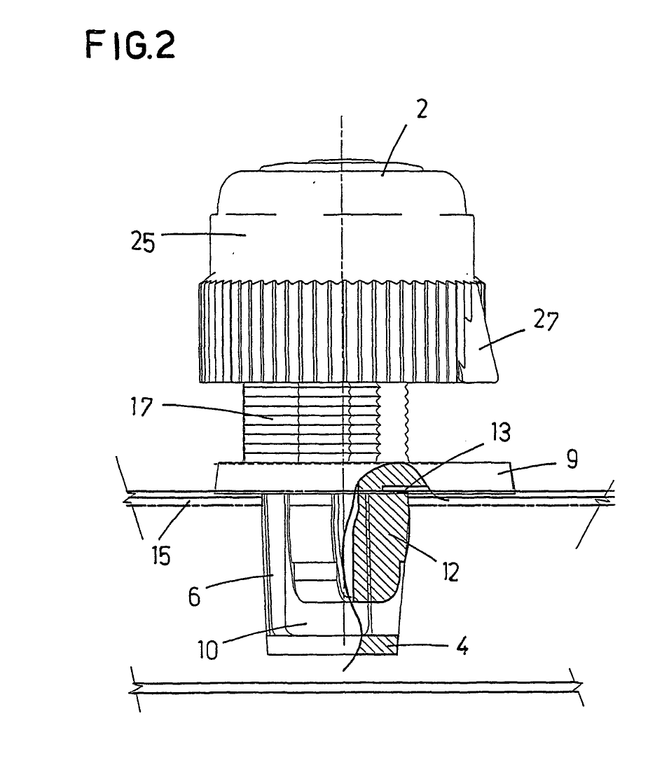

FIG. 2 is a side view of the stopper in FIG. 1 inserted into a seat made on the body of the motor vehicle, and

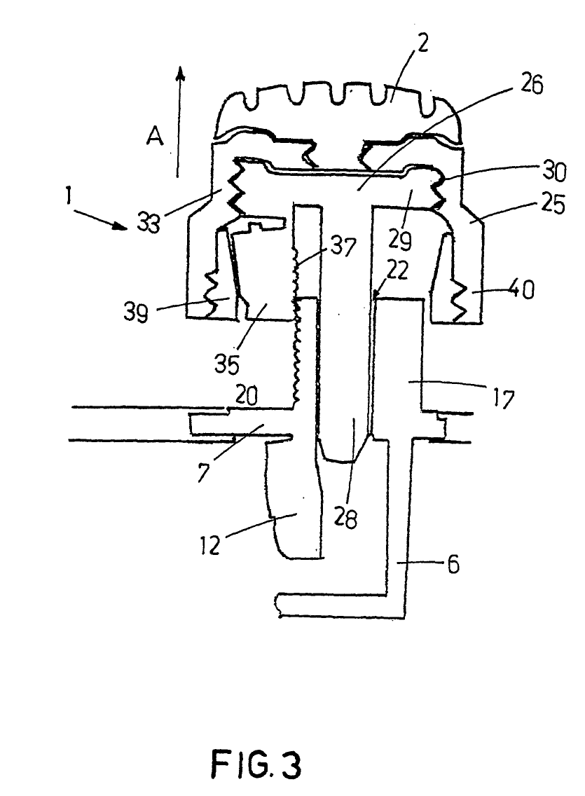

FIG. 3 is a section view of the stopper in FIG. 1.

With reference to the figures, reference number 1 indicates the overall bump stopper, completely made of plastic material, with the exception of a rubber cap 2, adapted to a mobile part of the body of a motor vehicle, such as a hatchback door or a bonnet, According to the invention, the stopper consists of a fixed element 3, the shape of which is basically triangular, presenting a base 4 the shape of which is that of an equilateral triangle with flat vertexes. From the vertexes three standards 6 start, the triangular sections of two of them being the same in size, and the third triangular section being smaller. The standards get slightly wider so that they form a cone structure and stop against a circular diaphragm 7 protruding from the external profile of the standards and provided with a reference protuberance for its angular position. The standards 6 define three rectangular windows and from each one of these windows a flexible tooth 12 protrudes which is integral with the diaphragm 7 and provided with a notch 13 intended to snap the fixed element 3 into a seat of proper shape made on the plate of the car body (or on the plastic sheet in case of a car body made of plastic material).

On the upper face of the diaphragm 7, an upper triangular element 17 is placed coaxially to and integral with it, the upper element presenting at its vertexes external rectangular lobes 18 extending by the bisecting line of the corresponding angle. The side faces of the upper triangular element 17 are provided with horizontal indentation 20, while an axial hole of basically triangular section 22, one of the walls of which is slightly bent with the concavity being towards the external part of the hole, is made inside said body 17.

Besides, the stopper 1 consists of a mobile element 25, the shape of which is that of a circular cup lid, the external face of which is provided with a knurling 26, and on it the rubber cap 2 is fixed. Besides, the external face of the mobile element 25 is provided with a triangle-shaped indicator for its angular position 27.

Inside the mobile element 25 there is a mushroom-shaped element 26, the longitudinal section of which is basically T-shaped. The section of the stem 28 of the T is basically triangular with a concave face, its dimensions being such that it can be easily inserted into the hole 22 in a position that allows the two concave faces of the hole 22 and of the stem 28 to face each other. The circumference of the head 29 of the T, is provided with a peripheral left-hand thread 30 adapted to get engaged with a corresponding thread made on the internal wall of the lid (mobile element) 25 in the part where its presents a smaller diameter. Three appendixes 35 of composite shape are connected to the lower face of the head 29 by means of plastic film hinges, the appendixes being equally spaced along the inner circumference of the lid 25 and basically parallel to the stem 28. The external outline of said appendixes is that of a truncated cone, the diameter diminishing towards the external part of the lid, while the internal outline reproduces the outline of the side wall of the triangular element 17 including the lobes 18, and is provided with an indentation 37 which is the same as the one on the triangular body, so that it can get coupled to it.

A ring 39, the internal outline of which is that of a truncated cone with the inner diameter increasing upwards (FIG. 3), is connected by means of a thread 40 to the internal wall of the lid 25 next to the lower edge, facing the appendixes 35, so that its cone surface interacts with the cone surface of the appendixes when these are translated along the axis of the T-shaped element.

The stopper according to the present invention works as follows.

The fixed element 3 is snap inserted, by means of the flexible teeth 12, into the hole in the plate/plastic of the car body, in the only angular position allowed due to the fact that the outline of one of the standards is different from the outline of the other two standards. The position of the protuberance 9 contributes to determine that the fixed element 3 is inserted correctly.

The mobile element 25 can be inserted on the fixed element after it has been locked, or can be assembled together with the fixed element in its initial position, that is with the stem inserted into the hole 22 and with the first part of the indentation 37 of the appendixes 35 engaged with the first part of the indentation 20 of the upper triangular element 17.

In this position, the mobile element is free to get driven on the upper element 17 as a consequence of a slight pressure on the cap 2. At this point the mobile part of the car body is bump shut against the bump stopper so that the mobile element is pushed and driven into the upper element 17 just enough to let the mobile part of the car body get positioned edge-wise with the fixed element, in its final closing position, thus compensating for the differences in clearance between the framework and the channel.

Once the mobile part of the car body is opened again, the mobile element 25 is manually rotated clockwise on the left-hand thread 33, so that it translates upwards (arrow a in FIG. 3) dragging with it the ring 39, the truncated cone wall of which acts on the external wall of the appendixes 35, while the T-shaped element remains still, being locked by the stem 28 inserted into the axial hole 22. The appendixes are thus compressed against the upper element 17 and the indentations 37 are forced to get firmly coupled to the indentations 20 thus preventing any subsequent relative movement between the fixed element and the mobile element.

The upwards translation of the element 25 (arrow A), makes the stopper to be lifted, so that it is possible to elastically lock the mobile part of the car body (hatchback door or bonnet) which, in order to engage the lock must compress the rubber cap. An elastic locking of a predetermined value is thus achieved by means of the simple manual rotation of the mobile element 25. Constancy in measures is given both from the fact that said rotation stops when locking between the mobile element and the fixed element is achieved, being it achieved always at the same point, and from the control of the reciprocal position of the indicators on the mobile element and on the diaphragm.

1. Plastic bump stopper for a mobile part of the body of a motor vehicle, consisting of a fixed element (3) that can be fixed into a seat of the car body and of a mobile element (25) that can be coaxially connected to the fixed element, and can be translated along its axis in order to separate it from the fixed element by means of a clockwise rotation, and that can be locked on a part (17) of said fixed element into the desired position, as a consequence of said rotation, through locking means (35, 37), characterised in that the fixed element (3) presents a basically triangular section and can be snapped into a hole seat the outline of which corresponds to that of the fixed element, made on a fixed part (15) of the car body and that the mobile element (25) presents a basically circular section and is provided with means (28) to fit it, in a predefined angular position, on an upper element (17) of said fixed element external to the car body.

2. Bump stopper as claimed in claim 1 characterised in that the fixed element (3) consists of a triangular base from the vertexes of which start three standards (6) which get wider in order to form a basically cone structure that reaches a circular diaphragm (7) the diameter of which is such that it protrudes from the external profile of said standards; the upper face of said diaphragm being provided with a triangular body (17) at the vertexes of which there are rectangular lobes (18) that extend along the bisecting line of the corresponding angle, said triangular element having a diameter shorter than the diameter of the diaphragm (7).

3. Bump stopper as claimed in claim 1 and claim 2 characterised in that the standards (6), the base (4) and the diaphragm (7) define windows (10) from which protrude means intended for the fixing to the car body in the form of flexible teeth (12) provided of engaging notches (13).

4. Bump stopper as claimed in claim 2 characterised in that the diaphragm (7) presents a protuberance (9) as a reference for its angular position.

5. Bump stopper as claimed in claim 2 characterised in that one of the standards (6) presents a section which is different from those of the others which are identical among them.

6. Bump stopper as claimed in claim 2 characterised in that the upper triangular element (17) presents a horizontal indentation on its side walls.

7. Bump stopper as claimed in claim 2 characterised in that the upper triangular element (17) presents an axial hole the section of which is basically triangular (22), said hole presenting a slightly bent wall the concavity being towards the external part of the hole.

8. Bump stopper as claimed in claim 1 characterised in that the mobile element (25) is cup-lid shaped the external face of it being provided with a knurling (26) and with a triangular indicator for the angular position, a rubber cap (2) being fixed on the upper face of said lid.

9. Bump stopper as claimed in claim 1 characterised in that inside the cup-lid element (25) there is a mushroom-shaped element (26) the longitudinal section of which is basically T-shaped, the head of the T presenting a peripheral left-hand thread 30 adapted to become engaged with a corresponding thread made on the internal wall of the lid (25).

10. Bump stopper as claimed in claim 7 and claim 9 characterised in that the mushroom-shaped element (26) presents a coaxial stem the section of which is basically triangular, with a concave face and the outline and dimensions of which are such that it can be inserted in said axial hole (22) of the upper element (17).

11. Bump stopper as claimed in any of the previous claims characterised in that connected to the lower inner edge of the lid element (25) there is a ring (39) the internal outline of which is that of a truncated cone the diameter of which increases towards the inner part of the lid and which is adapted to co-operate with appendixes (35) connected to the head (29), placed basically parallel to the stem (28) and equally spaced along the inner circumference of the lid; said appendixes presenting a truncated cone external outline with a diameter decreasing towards the edge of the lid and an inner outline basically as that of one of the side walls of the upper triangular element (17) and provided with horizontal knurling (37) adapted to get coupled with the knurling (20) of the triangular body (17) when pushed against it by the relative translation between the mobile element (25) and the mushroom-shaped element (26) as a consequence of the counterclockwise rotation of the mobile element (25).

12. Bump stopper as claimed in claim 11 characterised in that the ring 38 is fixed to the mobile lid element (25) by means of a thread made near the lower edge.

13. Bump stopper as claimed in claim 11 characterised in that the appendixes (35) are connected to the head (29) by means of thin film hinges.
